(19) United States
(12) Patent Application Publication
(10) Pub. No.: US 2011/0135139 A1
(43) Pub. Date: Jun. 9, 2011

(54) SPEAKER DEVICE

(75) Inventor: Kei Tanabe, Iwaki (JP)

(73) Assignee: Alpine Electronics, Inc., Shinagawa-ku (JP)

(21) Appl. No.: 12/958,026

(22) Filed: Dec. 1, 2010

(30) Foreign Application Priority Data
Dec. 7, 2009 (JP) 2009-277628

(51) Int. Cl. H04R 11/02

(52) U.S. Cl. 381/400

(57) ABSTRACT

A speaker device includes a voice coil unit and a diaphragm linked to the voice coil unit. A first supporting unit and a second supporting unit elastically support the end portions of the voice coil unit so that the voice coil portion of the voice coil unit can vibrate within the magnetic gap in the direction of the face thereof. Each of the first supporting unit and the second supporting unit has a configuration that is in a shape bent so as to extend up and bend down from an end that is fixed to a fixing position. Thus, a speaker device in which the voice coil unit can vibrate with a greater amplitude is provided.

### RELATED APPLICATION

The present application claims priority to Japanese Patent Application Number 2009-277628, filed Dec. 7, 2009, the entirety of which is hereby incorporated by reference.

### BACKGROUND OF THE INVENTION

1. Field of the Invention

The present invention relates to a speaker device that outputs sound by vibrating a diaphragm which is connected to a voice coil by mutual action between a magnetic field generated in a magnetic circuit and an audio signal current that flows through the voice coil.

2. Description of the Related Art

Heretofore, an angular and thin-shaped speaker device has been proposed (see Japanese Unexamined Utility Model Registration Application Publication No. 58-48194). This speaker device is configured so that a flat drive plate (voice coil unit) formed of a voice coil is disposed within a magnetic gap formed by two magnets, and one end portion of the drive plate is attached to the back face of the flat diaphragm. The other end portion of the drive plate is elastically supported by a supporting member so that the drive plate can vibrate within the magnetic gap in a direction parallel to the face thereof. With such a configuration, the drive plate vibrates in a direction parallel to the face thereof by mutual action between the audio signals supplied to the voice coil and the magnetic flux that cuts across the magnetic gap, and sound is output corresponding to the audio signals by the flat diaphragm, to which the vibrating drive plate is attached.

However, with the above-described current speaker device, one end portion of the drive plate (voice coil unit) is attached to the flat diaphragm and the opposite end portion of the drive plate is elastically supported by a supporting member, whereby obtaining amplitude by the drive plate (voice coil unit) in the direction parallel to the face thereof is difficult. Therefore, obtaining a loud audio output is difficult.

The present invention takes this situation into account, and provides a speaker device wherein the voice coil unit can vibrate with a greater amplitude.

### SUMMARY

A speaker device according to one embodiment of the present invention has a configuration including a magnetic circuit forming a magnetic gap; a voice coil unit disposed in the magnetic gap; and a diaphragm linked to the voice coil unit. The voice coil unit further includes a voice coil line patterns formed on the surface of a flat flexible material, and a first supporting unit and a second supporting unit that elastically support the voice coil unit, which are formed following both end portions of the voice coil portion of the flat flexible material. An end portion of the first supporting unit and the second supporting unit, which is on the side opposite from the voice coil portion, is fixed to a fixing position to enable vibrations of the voice coil portion within the magnetic gap in the direction of the face thereof and each of the first supporting unit and the second supporting unit elastically support the voice coil portion in a shape that extends up and bends down from the end portion that is fixed to the fixing position.

With such a configuration, each of the first supporting unit and the second supporting unit following from both end portions of the voice coil portion disposed within the magnetic gap formed in the magnetic circuit are elastically supporting the voice coil portion in a form that extends up from the end portion fixed to the fixing position and bends down, whereby when the voice coil portion vibrates within the magnetic gap in the face direction thereof, the vibrations of the voice coil portion are maintained while deforming the bent form of each of the first supporting unit and the second supporting unit in accordance with the vibrations of the voice coil portion.

The speaker device may have a configuration wherein connecting points are formed at the edge portions fixed to the fixing position of at least one of the first supporting unit and the second supporting unit, and a line pattern following the connecting points through the voice coil line pattern is formed on the at least one of the first supporting unit and the second supporting unit.

With such a configuration, a connecting point connected to the voice coil line pattern is formed on at least one end portion of the first supporting unit and the second supporting unit fixed to the fixing position, whereby a lead line supplying an audio signal to the voice coil line pattern via the connecting points can be distributed without influence from the vibrations of the voice coil portion.

Also, the speaker device may have a configuration further including positioning members that determine the positions of parts making up the magnetic circuit, wherein the fixing positions to which the end portions of each of the first supporting unit and the second supporting unit are fixed are set in the positioning members.

With such a configuration, the end portions of each of the first supporting unit and the second supporting unit that elastically support the voice coil portion are fixed by the positioning members that determine positions of the parts making up the magnetic circuit, whereby assembly of the magnetic circuit and the voice coil unit can be easily performed.

The speaker device may have a configuration wherein the fixing positions to which at least one of the edge portions of the first supporting member and the second supporting member on which the connecting points are formed is fixed, is set so as to be a concave portion, and by fitting the terminal member having corresponding connecting points into the concave portion, the audio signal from the outside is supplied to the voice coil line pattern via the terminal member.

With such a configuration, by fitting the terminal member into the concave portion wherein the fixing position is set, to which at least one end portion of the first supporting unit and the second supporting unit is fixed, the audio signal is supplied to the voice coil line pattern via the terminal member, whereby the audio signal can be supplied to the voice coil line pattern without soldering.

A speaker device according to an embodiment of the present invention has a configuration including a magnetic circuit forming a magnetic gap; a voice coil unit disposed in the magnetic gap; and a diaphragm linked to the voice coil unit, the magnetic circuit further forming two facing magnetic gaps. The voice coil unit includes a first voice coil portion including a first voice coil line pattern formed on the surface of a flat flexible material; a second voice coil portion including a second voice coil line pattern formed on the surface of a flat flexible material; a first-first supporting unit and a second-first supporting unit which are formed following both edge portions of the first voice coil portion of the flat flexible material, and which elastically support the first voice coil portion; a first-second supporting unit and a second-second supporting unit which are formed following both edge portions of the second voice coil portion of the flat flexible material, and which elastically support the second voice coil portion; wherein the edge portion on the side opposite from the first voice coil portion of each of the first-first supporting unit and the second-first supporting unit is fixed to fixing positions so as to enable vibration of the first voice coil portion in one of the magnetic gaps in the direction of the face thereof; wherein the edge portion on the side opposite from the second voice coil portion of each of the first-second supporting unit and the second-second supporting unit is fixed to fixing positions so as to enable vibration of the second voice coil portion in the other of the magnetic gaps in the direction of the face thereof; wherein each of the first-first supporting unit and the second-first supporting unit elastically supports the first voice coil portion in a bent shape that extends up from the end portion fixed to the fixing position and bends down; and wherein each of the first-second supporting unit and the second-second supporting unit elastically supports the second voice coil portion in a bent shape that extends up from the end portion fixed to the fixing position and bends down.

With such a configuration, each of the first-first supporting unit and the second-first supporting unit following from the end portions of the first voice coil portion disposed in one of the magnetic gaps formed in the magnetic circuit elastically supports the first voice coil portion in a form that extends up from the end portions fixed to the fixing position and bends down, and each of the first-second supporting unit and the second-second supporting unit following from the end portions of the second voice coil portion disposed in the other of the magnetic gaps formed in the magnetic circuit elastically supports the second voice coil portion in a form that extends up from the end portions fixed to the fixing positions and bends down, whereby when the first voice coil portion and the second voice coil portion vibrate within the magnetic gaps in the direction of the faces thereof, the vibration of the first voice coil portion is maintained while deforming the bent form of each of the first-first supporting unit and the second-first supporting unit in accordance with the vibrations of the first voice coil portion, and also, the vibration of the second voice coil portion is maintained while deforming the bent form of each of the first-second supporting unit and second-second supporting unit in accordance with the vibrations of the second voice coil portion.

The speaker device may have a configuration wherein a connecting point is formed on the end portion fixed to at least one of the fixing positions of the first-first supporting unit and the second-first supporting unit of the voice coil unit, and a line pattern following the connecting point through the first voice coil line pattern is formed on at least one of the first-first supporting unit and the second-first supporting unit including the connecting point on the end portion.

With such a configuration, a connecting point connected to the first voice coil line pattern is formed on at least one end portion of the first-first supporting unit and the second-first supporting unit fixed to the fixing position, whereby the lead line supplying the audio signal to the first voice coil line pattern via the connecting point can be distributed without influence from the vibration of the first voice coil portion.

The speaker device may have a configuration wherein a connecting point is formed on the end portion fixed to at least one of the fixing positions of the first-second supporting unit and the second-second supporting unit, and a line pattern following the connecting point through the second voice coil line pattern is formed on at least one of the first-second supporting unit and the second-second supporting unit including the connecting point on the end portion.

With such a configuration, a connecting point connected to the second voice coil line pattern is formed on at least one end portion of the first-second supporting unit and the second-second supporting unit fixed to the fixing position, whereby the lead line supplying the audio signal to the second voice coil line pattern via the connecting point can be distributed without influence from the vibration of the second voice coil portion.

The speaker device may have a configuration further including positioning members that determine the position of the parts making up the magnetic circuit, wherein the fixing positions to which the end portions of each of the first-first supporting unit and the second-first supporting unit are fixed, and wherein the fixing positions to which the end portions of each of the first-second supporting unit and the second-second supporting unit are fixed, are set in the positioning members.

With such a configuration, each end portion of the first-first supporting unit and the second-first supporting unit that elastically supports the first voice coil portion is fixed by the positioning members that determine the position of the parts making up the magnetic circuit, and also, each end portion of the first-second supporting unit and the second-second supporting unit that elastically supports the second voice coil portion is fixed by the positioning members that determine the position of the parts making up the magnetic circuit, whereby assembly of the magnetic circuit and the voice coil unit can be performed easily.

The speaker device may have a configuration wherein the fixing positions to which at least one of the end portions of the first-first supporting unit and the second-first supporting unit is fixed, is set into a concave unit, and a terminal member having a corresponding connecting point is fit into the concave portion, whereby audio signals are supplied from the outside via the terminal member to the first voice coil line pattern.

With such a configuration, by fitting the terminal member into the concave portion wherein the fixing position is fixed, to which at least one end portion of the first-first supporting unit and the second-first supporting unit is fixed, the audio signal is supplied to the first voice coil line pattern via the terminal member without soldering.

The speaker device may have a configuration wherein the fixing positions to which at least one of the end portions of the first-second supporting unit and the second-second supporting unit whereupon the connecting point is formed is set into a concave unit, and a terminal member having a corresponding connecting point is fit into the concave portion, whereby audio signals are supplied from the outside via the terminal member to the second voice coil line pattern.

With such a configuration, by fitting the terminal member into the concave portion wherein the fixing position is fixed, to which at least one end portion of the first-second supporting unit and the second-second supporting unit is fixed, the audio signal is supplied to the second voice coil line pattern via the terminal member without soldering.

A speaker device according to an embodiment of the present invention may have a configuration wherein the first-first supporting unit that follows from one end portion of the first voice coil portion and the first-second supporting unit that follows from one end portion of the second voice coil portion are formed so as to be continuous, and the border portion between the first-first supporting unit and the first-second supporting unit is fixed to the first fixing position; and the second-first supporting unit that follows from the other end portion of the first voice coil portion and the second-second supporting unit that follows from the other end portion of the second voice coil portion are formed so as to be continuous, and the border portion between the second-first supporting unit and the second-second supporting unit is fixed to the second fixing position.

With such a configuration, the first-first supporting unit and the second-first supporting unit following the first voice coil portion and the first-second supporting unit and the second-second supporting unit following the second voice coil portion are formed so as to be continuous, whereby the first voice coil portion, the second voice coil portion, the first-first supporting unit, the second-first supporting unit, the first-second supporting unit, and the second-second supporting unit can be made from the same piece of flat flexible material, and the construction of the voice coil unit can be made simpler.

Also, each of the first-first supporting unit and the first-second supporting unit following one end portion of the first voice coil portion and the second voice coil portion elastically supports one end portion of the first voice coil portion and the second voice coil portion in a form that extends up from the border portions wherein the supporting units are fixed to a first fixing position and bends down, and each of the second-first supporting unit and the second-second supporting unit following the other end portion of the first voice coil portion and the second voice coil portion elastically supports the other end portion of the first voice coil portion and second voice coil portion in a form that extends up from the border portions wherein the supporting units are fixed to a second fixing position and bends down, whereby when the voice coil portion vibrates within the magnetic gap in the face direction thereof, the vibration of the voice coil portion is maintained while deforming the bent form of each of the first supporting unit and the second supporting unit in accordance with the vibration of the voice coil portion, and the vibration of the voice coil portion is maintained while deforming the bent form of each of the first supporting unit and the second supporting unit in accordance with the vibration of the voice coil portion.

The speaker device may have a configuration wherein a connecting point is formed on at least one of the border portion between the first-first supporting unit and the first-second supporting unit and the border portion between the second-first supporting unit and the second-second supporting unit, wherein a line pattern that follows the connecting point through the first voice coil line pattern and the second voice coil line pattern is formed on at least one of the first-first supporting unit and the first-second supporting unit and the second-first supporting unit and the second-second supporting unit.

With such a configuration, on at least one of the border portion between the first-first supporting unit and the first-second supporting unit fixed to the first and second fixing positions and the border portion between the second-first supporting unit and the second-second supporting unit, a line pattern following the connecting point through the first voice coil line pattern and the second voice coil line pattern is formed on at least one of the first-first supporting unit and the first-second supporting unit and the second-first supporting unit and the second-second supporting unit, whereby a lead line supplying an audio signal to the first voice coil line pattern and the second voice coil line pattern via the connecting point can be distributed without influence from the vibration of the first voice coil portion and the second voice coil portion.

The speaker device may have a configuration further including positioning members that determine the position of the parts making up the magnetic circuit, wherein the fixing positions to which the border portions of each of the first-first supporting unit and the first-second supporting unit are fixed, and wherein the fixing positions to which the border portions of each of the second-first supporting unit and the second-second supporting unit are fixed, are set in the positioning members.

With such a configuration, the border portion between the first-first supporting unit that elastically supports the first voice coil portion and the first-second supporting unit that elastically supports the second voice coil portion, and the border portion between the second-first supporting unit that elastically supports the first voice coil portion and the second-second supporting unit that elastically supports the second voice coil portion, are fixed by the positioning members that determine the position of the parts making up the magnetic circuit, whereby assembly of the magnetic circuit and the voice coil unit can be performed easily.

The speaker device may have a configuration wherein at least one of the first fixing position and the second fixing position, where at least one of the border portion between the first-first supporting unit and the first-second supporting unit on which the connecting point is formed, and the border portion between the second-first supporting unit and the second-second supporting unit is fixed, is set into a concave portion; and wherein a terminal member having a corresponding connecting point is fit into the concave portion, whereby audio signals are supplied from the outside via the terminal member to the first voice coil line pattern and the second line pattern.

With such a configuration, by fitting the terminal member into the concave portion wherein at least one of the first fixing position and second fixing position has been set, to which at least one of the border portion between the first-first supporting unit and the second-first supporting unit and the border portion between the second-first supporting unit and the second-second supporting unit is fixed, the audio signal is supplied to the first voice coil line pattern and the second voice coil line pattern via the terminal member, whereby the audio signal can be supplied to the first voice coil line pattern and the second voice coil line pattern without soldering.

According to these embodiments of the speaker device, when a voice coil portion vibrates within the magnetic gap in the direction of the face thereof, the vibrations of the voice coil portion are maintained while deforming the bent form of the first supporting unit and the second supporting unit in accordance with the vibrations of the voice coil portion, whereby in the amount that the bent forms of the first supporting unit and the second supporting unit that extend up and bend down are deformed, the amplitude of the vibrations of the first and second voice coil portions that are elastically supported can be increased. Accordingly, a speaker device can be realized wherein the voice coil unit can vibrate with a greater amplitude.

### BRIEF DESCRIPTION OF THE DRAWINGS

FIG. 1 is a perspective diagram illustrating an external view of a speaker device unit according to an embodiment of the present invention;

FIG. 2 is a cross-sectional diagram showing a cross-sectional configuration of the speaker device shown in FIG. 1 cut away along a line II-II;

FIG. 3 is a perspective diagram showing a configuration of a first inner yoke;

FIG. 4 is a perspective diagram illustrating a magnetic plate;

FIG. 5 is a perspective diagram illustrating a configuration of a second inner yoke;

FIG. 6A is a perspective diagram illustrating a configuration of a first positioning member;

FIG. 6B is a perspective diagram illustrating a configuration of a second positioning member;

FIG. 7 is a perspective diagram illustrating a first outer yoke and a second outer yoke as a pair;

FIG. 8 is a perspective diagram illustrating a configuration of a frame member;

FIG. 9 is a perspective diagram illustrating a configuration of a voice coil unit relating to the first embodiment of the present invention;

FIG. 10 is a perspective diagram illustrating a configuration of a damper member;

FIG. 11 is a perspective diagram illustrating a diaphragm;

FIG. 12 is a perspective diagram illustrating a first horizontal edge portion and a second horizontal edge portion;

FIG. 13A is a plan view illustrating an example of a voice coil array pattern formed in the voice coil unit;

FIG. 13B is a plan view illustrating another example of a voice coil array pattern formed in the voice coil unit;

FIG. 14 is a perspective diagram illustrating a configuration unit formed by layering the magnetic plate over the second inner yoke;

FIG. 15 is a perspective diagram illustrating a configuration unit formed by sandwiching the magnetic plate between the first inner yoke and the second inner yoke;

FIG. 16 is a perspective diagram illustrating a new configuration unit formed by attaching to the configuration unit shown in FIG. 15 the first positioning member and the second positioning member;

FIG. 17 is a perspective diagram illustrating a new configuration unit in a state wherein the first outer yoke and the second outer yoke are further set in the first positioning unit and the second positioning unit of the configuration unit shown in FIG. 16;

FIG. 18 is a perspective diagram showing a new configuration unit formed by attaching the frame member to the configuration unit shown in FIG. 17;

FIG. 19 is a perspective diagram showing a new configuration unit formed by attaching the voice coil unit to the configuration unit shown in FIG. 18;

FIG. 20 is a perspective diagram illustrating a new configuration unit formed by attaching the damper member to the configuration unit shown in FIG. 19;

FIG. 21 is a partial expanded perspective diagram illustrating a fixed configuration of a first vertical edge unit (second vertical edge unit) and frame member in the configuration unit shown in FIG. 20;

FIG. 22 is a perspective diagram illustrating a new configuration unit formed by attaching a diaphragm to the configuration unit shown in FIG. 20;

FIG. 23 is a partially expanded perspective diagram illustrating a fixed configuration of a damper member and diaphragm of a configuration unit shown in FIG. 22;

FIG. 24A is a perspective diagram illustrating an expansion of a state wherein a second terminal unit of the voice coil unit is set in a terminal set face of a second positioning member;

FIG. 24B is a perspective diagram illustrating an expansion of a fixed configuration of the second terminal unit of the voice coil unit that has been set in the terminal set face of the second positioning member; and

FIG. 25 is a diagram showing a magnetic flux within a magnetic circuit in a speaker device of the configuration shown in FIG. 2.

### DESCRIPTION OF THE PREFERRED EMBODIMENTS

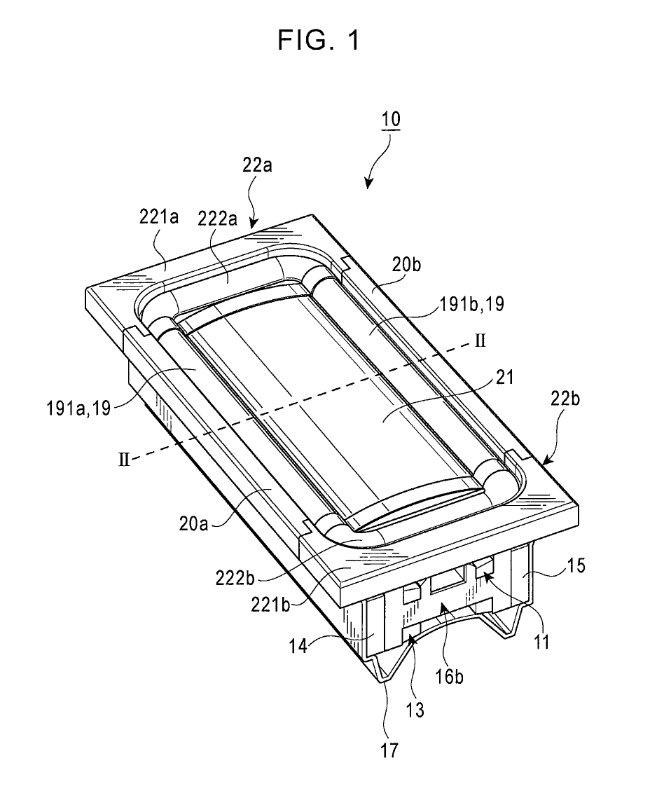

Embodiments of the present invention will be described below with reference to the appended diagrams. An external view of a speaker device according to an embodiment of the present invention is shown in FIG. 1.

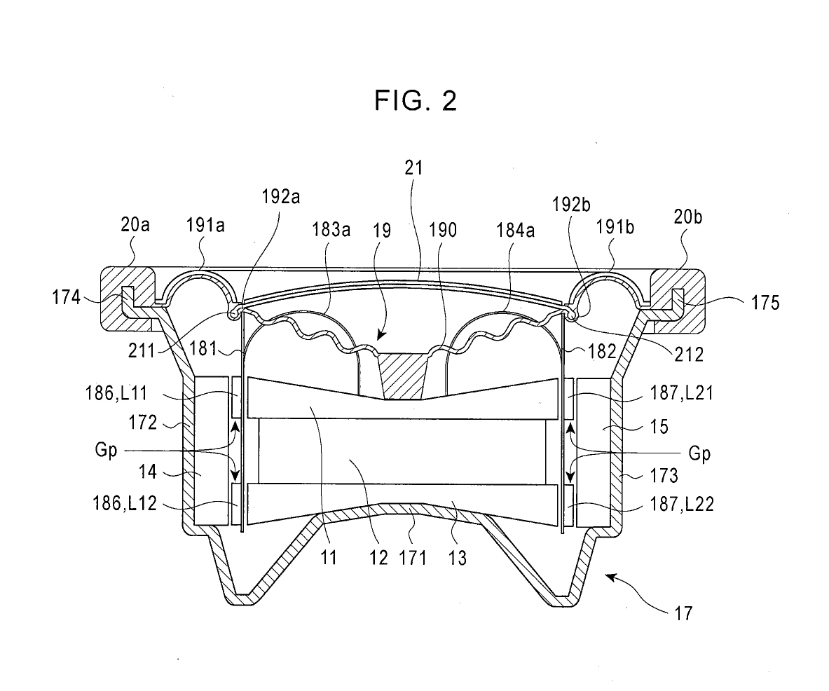

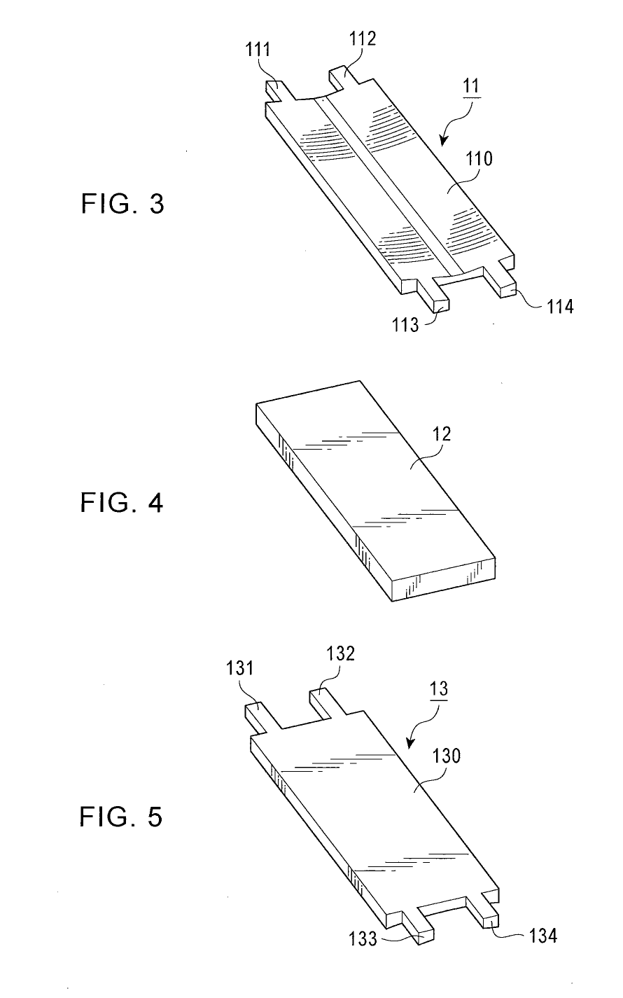

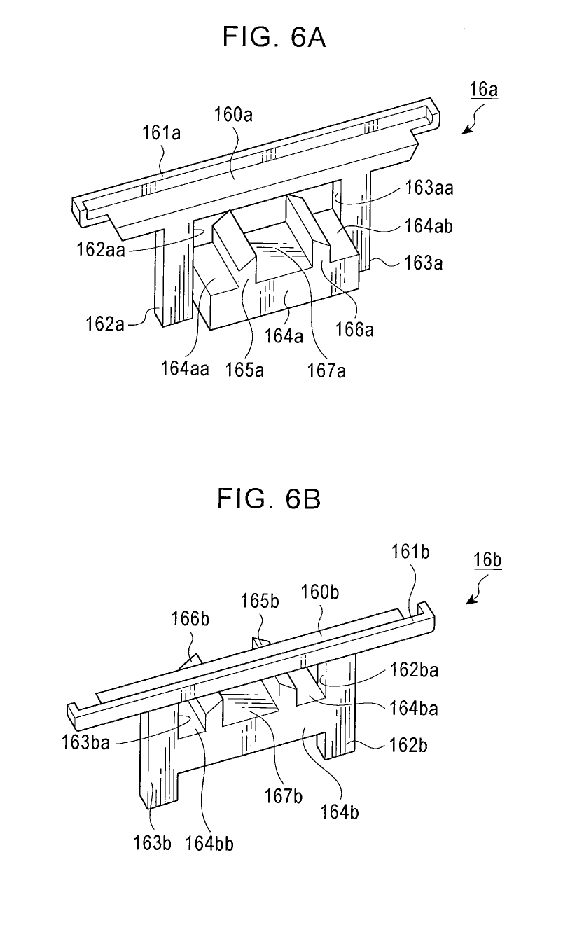

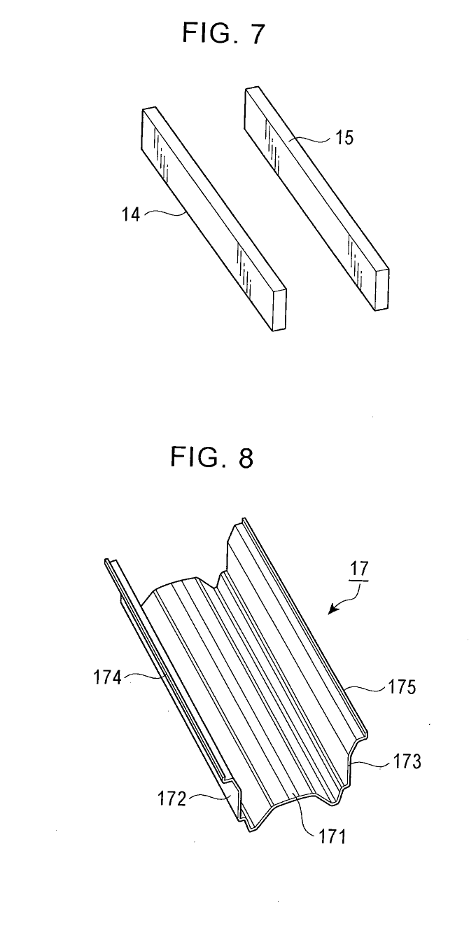

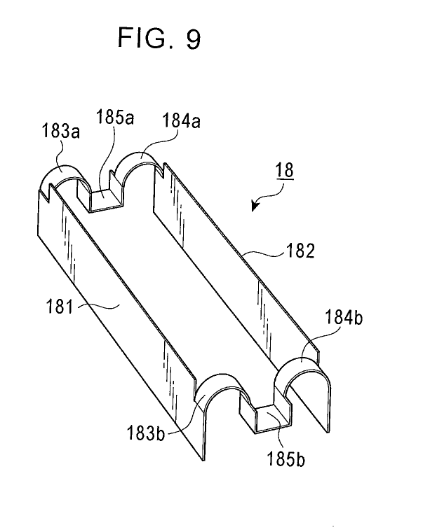

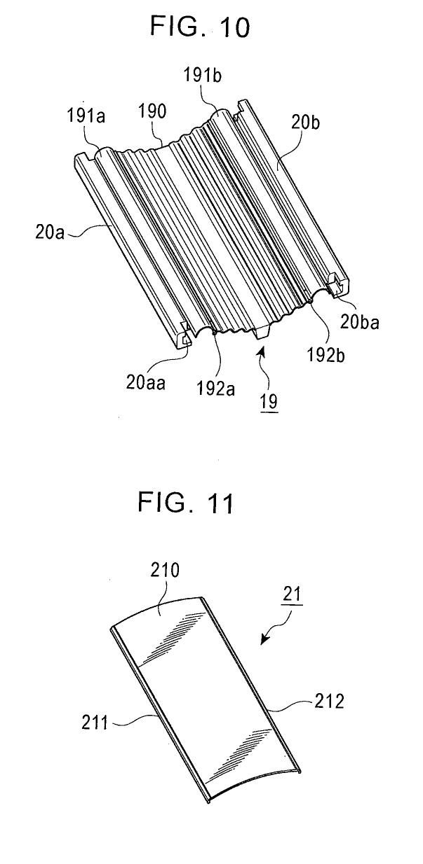

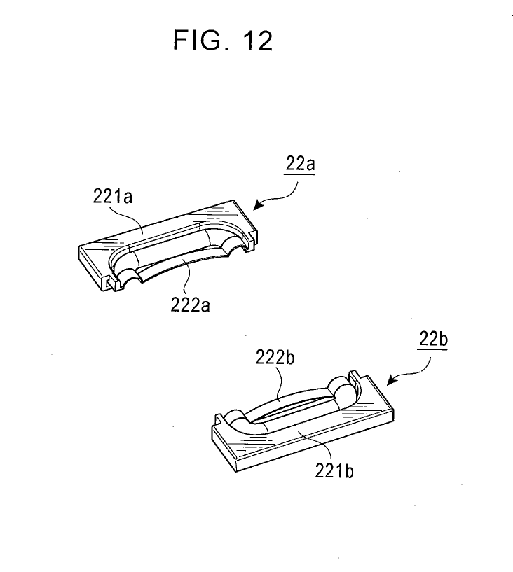

A speaker device 10 shown in FIG. 1 is an angular shaped speaker device, is configured with the parts shown in FIGS. 3 through 12, and has the cross-sectional configuration shown in FIG. 2. Specifically, the speaker device 10 is formed by assembling the various parts of a rectangular plate-shaped metallic first inner yoke 11 shown in FIG. 3, a rectangular plate-shaped magnetic plate 12 shown in FIG. 4, a rectangular plate-shaped metallic second inner yoke 13 shown in FIG. 5, a first positioning member 16a made of a non-magnetic body (for example, a resin) shown in FIG. 6A, a second positioning member 16b made of a non-magnetic body (for example, a resin) shown in FIG. 6B, a first outer yoke 14 and a second outer yoke 15 shown in FIG. 7, a frame member 17 shown in FIG. 8, a voice coil unit 18 shown in FIG. 9, a damper member 19 shown in FIG. 10, a diaphragm 21 shown in FIG. 11, and a first horizontal edge unit 22a and a second horizontal edge unit 22b shown in FIG. 12.

The first inner yoke 11 (second inner yoke 13) shown in FIG. 3 (FIG. 5) has a configuration wherein positioning protrusions 111 and 112 (131 and 132) are formed as a pair on one end portion of the lengthwise direction of the rectangular plate-shaped yoke main unit 110 (130), while positioning protrusions 113 and 114 (133 and 134) are formed as a pair on the other end portion. Spacing of each pair of the positioning protrusions 111, 112 (131, 132) (113, 114) (133, 134), specifically, the distance between the external side faces, are set to predetermined lengths. The magnetic plate 12 shown in FIG. 4 is formed as a rectangular plate shape having a plate face with a slightly smaller area than the plate faces of the yoke main units 110, 130 of each of the first inner yoke 11 and the second inner yoke 13.

The first positioning member 16a shown in FIG. 6A and the second positioning member 16b shown in FIG. 6B are used to determine the positions of the first inner yoke 11, the second inner yoke 13, the first outer yoke 14, and the second outer yoke. The configuration of the first positioning member 16a will be described below, and the second positioning member 16b has the same configuration. In FIG. 6A (FIG. 6B), an angular-rod shaped first horizontal spacer unit 162a (162b) and a second horizontal spacer unit 163a (162b) are formed on a horizontal bar 160a (160b) so as to extend down therefrom. The spacing of the inner face 162aa (162ba) of the first horizontal spacer unit 162a (162b) and the inner face 163aa (163ba) of the second horizontal spacer unit 163a (163b) is set to the same distance as between the outer side face of the protrusion pairs 111, 112 (131, 132), (113, 114), (133, 134) of each of the above-described first inner yoke 11 and second inner yoke 13. Also, the width in the horizontal direction for each of the first horizontal spacer unit 162a (162b) and the second horizontal spacer unit 163a (163b) is set to a value corresponding to the spacing that the spacers should have. Note that the width is determined taking into account the horizontal width of each of the first inner yoke 11 and the second inner yoke 13 and the magnetic gap Gp that is to be formed.

A rectangular-shaped vertical spacer unit 164a (164b) is formed between the first horizontal spacer unit 162a (162b) and the second horizontal spacer unit 163a (163b), so as to connect the generally center portion thereof in the vertical direction of the respective inner faces 162aa (162ba), 163aa (163ba) thereof. The thickness in the vertical direction of the vertical spacer unit 164a (164b) is set to a value that corresponds to the spacing that the spacer should have. Note that this thickness is determined taking into account the spacing that the first inner yoke 11 and the second inner yoke 13 are to maintain, i.e. the thickness of the magnetic plate 12. Two protruding portions 165a (165b) and 166a (166b) are formed on the upper face of the vertical spacer unit 164a (164b), so as to extend in the direction orthogonal to the direction that the horizontal bar 160a (160b) extends, and in the form whereby the upper outer edges are chamfered. The two protruding portions 165a (165b) and 166a (166b) are positioned symmetrically on the right and the left of the center of the upper face of the vertical spacer unit 164a (164b), at a predetermined spacing. With the two protruding portions 165a (165b) and 166a (166b), the upper face of the vertical spacer unit 164a (164b) is divided into three portions. The portion between the two protruding portions 165a (165b) and 166a (166b) becomes a terminal set face 167a (167b) where the terminal unit of the voice coil unit 18 is set, as described later; the portion between one of the protruding portions 165a (165b) and the first horizontal spacer unit 162a (162b) becomes a first positioning face 164aa (164ba) for determining the position of the first inner yoke 11; and further, the portion between the other protruding portion 166a (166b) and the second horizontal spacer unit 163a (163b) becomes a second positioning face 164ab (164bb) for determining the position of the first inner yoke 11. The spacing between one of the protruding portions 165a (165b) and the first horizontal spacer unit 162a (162b) is set so as to correspond to the width of the positioning protrusion 111 (114) of the first inner yoke 11, and the spacing between the other protrusion 166a (166b) and the second horizontal spacer unit 163a (163b) is set so as to correspond to the width of the positioning protrusion 112 (113) of the first inner yoke 11. The lower face of the vertical spacer unit 164a (164b) which is on the opposite side from the upper face that is divided into three parts as described above becomes the positioning face to determine the position of the second inner yoke 13.

Note that an integrated outer frame unit 161a (161b) is formed on the horizontal bar 160a (160b). The outer frame unit 161a (161b) is linked to the first outer edge portion 174 and the second outer edge portion 175 of the frame member 17 to be described later, and forms an overall rectangular-shaped frame unit.

The first outer yoke 14 and the second outer yoke 15 shown in FIG. 7 are rectangular plate shapes, and along with the first inner yoke 11, the second inner yoke 13, and the magnetic plate 12, make up the magnetic circuit. The frame member 17 shown in FIG. 8 is formed by extrusion molding of metal or resin, and has a floor portion 171 having an arch shape on the inner side, a first pressing unit 172 that stands up following one of the end portions of the floor portion 171 and that is to press the first outer yoke 14 as will be described later, a second pressing unit 173 that stands up following the other end portion of the floor portion 171 and that is to press the second outer yoke 15 as will be described later, a first outer edge portion 174 formed following the first pressing unit 172, and a second outer edge portion 175 formed following the second pressing unit 173. The first outer edge portion 174 and the second outer edge portion 175 link with the outer frame portions 161a and 161b (see FIGS. 6A, 6B) of the first positioning member 16a and the second positioning member 16b as described above, to form the overall rectangular-shaped frame unit.

The voice coil unit 18 shown in FIG. 9 is of a configuration having a first voice coil portion 181 that is formed in a first voice coil array pattern on the surface of a flat flexible board, a second voice coil portion 182 that is formed in a second voice coil array pattern on the surface of the flat flexible board, a first-first supporting unit 183a that is formed following one edge portion of the first voice coil portion 181 and that is in a bent state and elastically supports the one edge portion of the first voice coil portion 181, a second-first supporting unit 183b that is formed following the other edge portion of the first voice coil portion 181 and that is in a bent state and elastically supports the other edge portion of the first voice coil portion 181, a first-second supporting unit 184a that is formed following one edge portion of the second voice coil portion 182 and that is in a bent state and elastically supports the one edge portion of the second voice coil portion 182, a second-second supporting unit 184b that is formed following the other edge portion of the second voice coil portion 182 and that is in a bent state and elastically supports the other edge portion of the second voice coil portion 182. The first-first supporting unit 183a that elastically supports the one edge portion of the first voice coil portion 181 and the first-second supporting unit 184a that elastically supports the one edge portion of the second voice coil portion 182 are formed so as to be continuous, and the border portion thereof becomes a first terminal unit 185a having a U-shaped cross-section. Also, the second-first supporting unit 183b that elastically supports the other edge portion of the first voice coil portion 181 and the second-second supporting unit 184b that elastically supports the other edge portion of the second voice coil portion 182 are formed so as to be continuous, and the border portion thereof becomes a second terminal unit 185b having a U-shaped cross-section.

With the voice coil unit 18 shown in FIG. 9, the first terminal unit 185a and the second terminal unit 185b are maintained horizontally, and the first-first supporting unit 183a and the second-first supporting unit 183b follow both ends of the first voice coil portion 181 of which the surface is bent in a semi-circle or reverse-U-shape so as to extend up from one side of the first terminal unit 185a and the second terminal unit 185b, and is vertically maintained. Also, the first-second supporting unit 184a and the second-second supporting unit 184b follow both ends of the second voice coil portion 182 of which the surface is bent in a semi-circle or reverse-U-shape so as to extend up from one side of the first terminal unit 185a and the second terminal unit 185b, and is vertically maintained. Thus, the first voice coil portion 181 that is elastically supported with the first-first supporting unit 183a and the second-first supporting unit 183b can vibrate in the direction of the face thereof (vertical direction), and the second voice coil portion 182 that is elastically supported with the first-second supporting unit 184a and the second-second supporting unit 184b can vibrate in the direction of the face thereof (vertical direction).

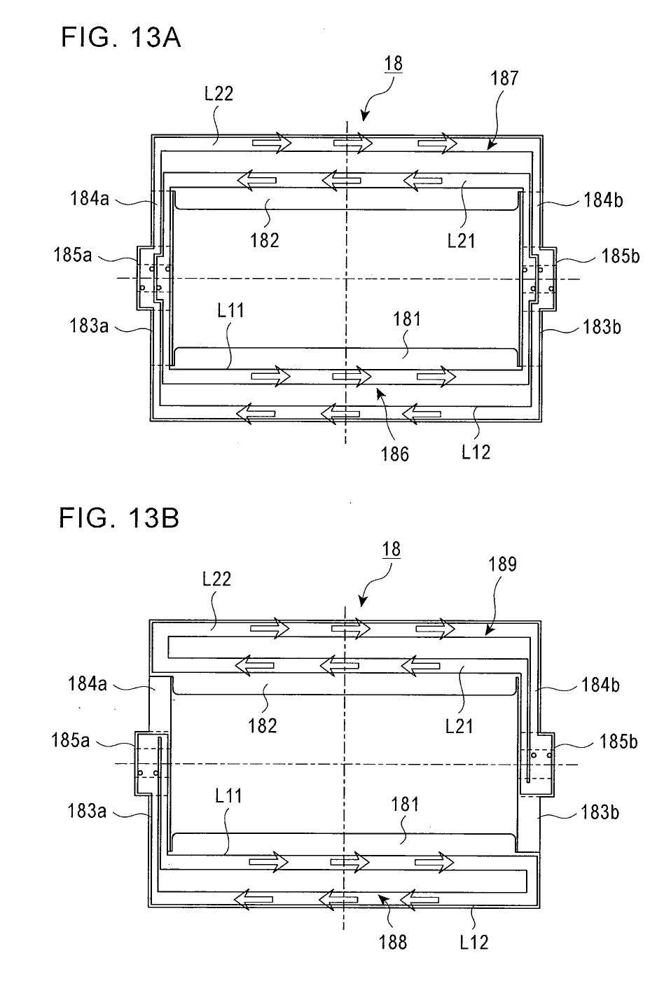

The voice coil unit 18 in a state that is laid out flat is shown in FIG. 13A. In FIG. 13A, a line pattern L11 is formed from the first terminal unit 185a through the first-first supporting unit 183a, the first voice coil portion 181 and the second-first supporting unit 183b to the second terminal unit 185b, and a line pattern L21 is formed from the second terminal unit 185b through the second-second supporting unit 184b, the second voice coil portion 182, and the first-second supporting unit 184a, following the line pattern L11, to return to the line pattern L11 of the first terminal unit 185a. That is to say, the line patterns L11 and L21 are formed circularly between the first terminal unit 185a, the first-first supporting unit 183a, the first voice coil portion 181, the second-first supporting unit 183b, the second terminal unit 185b, the second-second supporting unit 184b, the second voice coil portion 182, and the first-second supporting unit 184a. Also, on the outer side of the line patterns L11 and L21 which connect circularly, a line pattern L12 is formed from the first terminal unit 185a through the first-first supporting unit 183a, the first voice coil portion 181 and the second-first supporting unit 183b to the second terminal unit 185b, and a line pattern L22 is formed from the second terminal unit 185b through the second-second supporting unit 184b, the second voice coil portion 182, and the first-second supporting unit 184a, following the line pattern L12, to return to the line pattern L12 of the first terminal unit 185a. That is to say, the line patterns L12 and L22 are similarly formed circularly on the outer side of the line patterns L11 and L21 which connect circularly.

Two pairs of connecting points are formed on the first terminal unit 185a, and an audio signal is supplied to one pair of connecting points so that audio signal current flows to the line pattern L11 formed in the first voice coil portion 181 and the line pattern L21 formed in the second voice coil portion 182. Also, an audio signal is supplied to the other pair of connecting points so that audio signal current flows in the opposite direction from the audio current that flows in line patterns L11 and L21, to the line pattern L12 formed in the first voice coil portion 181 and the line pattern L22 formed in the second voice coil portion 182.

By forming the voice coil unit 18 of a laid-open configuration as shown in FIG. 13A to be in a form shown in FIG. 9, two line patterns L11 and L12 are arrayed above and below on the first voice coil portion 181, and a first voice coil line pattern 186 is configured with these line patterns L11 and L12. Also, two line patterns L21 and L22 are arrayed above and below on the second voice coil portion 182, and a second voice coil line pattern 187 is configured with these line patterns L21 and L22.

A line pattern such as shown in FIG. 13B can also be formed on the voice coil unit 18. In FIG. 13B which shows the voice coil unit 18 in a state that is laid out flat, a line pattern L11 is formed from the first terminal unit 185a through the first-first supporting unit 183a and the first voice coil portion 181 to the end portion of the first voice coil unit 181, and a line pattern L12 is formed from the end portion of the first voice coil portion 181, following the line pattern L11, through the first voice coil portion 181 and the first-first supporting unit 183a, to return to the first terminal unit 185a. That is to say, the line patterns L11 and L12 are formed in a ring shape through the first terminal unit 185a, the first-first supporting unit 183a, and first voice coil portion 181. Also, a line pattern L21 is formed from the second terminal unit 185b through the second-second supporting unit 184b and the second voice coil portion 182, to the end portion of the second voice coil unit, and a line pattern L22 is formed from the end portion of the second voice coil portion 182, following the line pattern L21, through the second voice coil portion 182 and the second-second supporting unit 184b, to return to the second terminal unit 185b. That is to say, the line patterns L21 and L22 are formed in a ring shape through the second terminal unit 185b, the second-second supporting unit 184b, and the second voice coil portion 182.

A pair of connecting points is formed on the first terminal unit 185a, and an audio signal is supplied to the connecting points making up this pair, whereby audio current flows in opposite directions in the line patterns L11 and L12 that are formed in a ring shape. Also, a pair of connecting points is formed on the second terminal unit 185b, and an audio signal is supplied to the connecting points making up this pair, whereby audio current flows in opposite directions in the line patterns L21 and L22 that are formed in a ring shape.

In the case that the voice coil unit 18 in the laid-open configuration as shown in FIG. 13B is formed into the shape shown in FIG. 9, two line patterns L11 and L12 are arrayed above and below on the first voice coil portion 181, similar to the case of the voice coil unit 18 in the configuration shown in FIG. 13A, and the first voice coil line pattern 188 is configured by the line patterns L11 and L12. Also, the two line patterns L21 and L22 are arrayed above and below on the second voice coil portion 182, and the second voice coil line pattern 189 is configured by the line patterns L21 and L22.

The damper member 19 shown in FIG. 10 is formed by extrusion molding of resin, and has a damper main unit 190 formed in a wave form, a first supporting unit 191a formed in an arch shape that follows one of the outer side edge portions of the damper main unit 190, and a second supporting unit 191b formed in an arch shape that follows the other outer side edge portion of the damper main unit 190. A first fitting groove 192a is formed in the border portion of the damper main unit 190 and the first supporting unit 191a so as to extend in the lengthwise direction, and a second fitting groove 192b is formed in the border portion of the damper main unit 190 and the second supporting unit 191b so as to extend in the lengthwise direction.

The diaphragm 21 shown in FIG. 11 is formed with a material such as resin, metal, paper, or the like, and has a diaphragm main unit 210 that is in a slightly bent state and a first slide unit 211 and a second slide unit 212 that slide and fit into the first fitting groove 192a and the second fitting groove 192b of the damper member 19 on both outer edges of the diaphragm main unit 210.

The first horizontal edge portion 22a and the second horizontal edge portion 22b shown in FIG. 12 are formed with a resin or the like, and as described above, has outer frame units 161a and 161b of the first positioning member 16a and the second positioning member 16b, and edge engaging portions 221a and 221b that engage so as to link to the first vertical edge portion 20a and the second vertical edge portion 20b that are fixed in the first outer edge portion 174 and the second outer edge portion 175 on both end portions in the lengthwise direction of the rectangular-shaped frame unit formed by the first outer edge portion 174 and the second outer edge portion 175 of the frame member 17 linking together. Also, edge cover portions 222a and 222b that fill in the spaces between the diaphragm 19 are formed so as to extend over the inner side of the edge engaging portions 221a and 221b.

The parts configured as described above (see FIGS. 3 through 12) are assembled as follows, whereby the speaker device 10 shown in FIG. 1 can be formed.

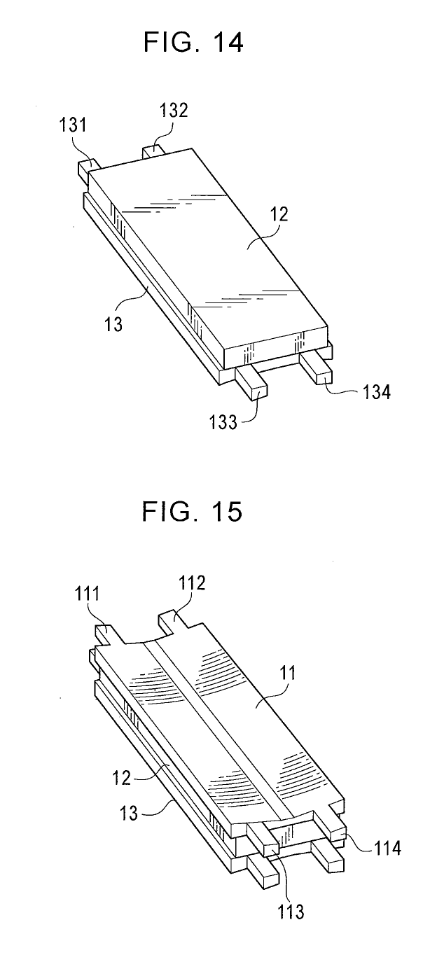

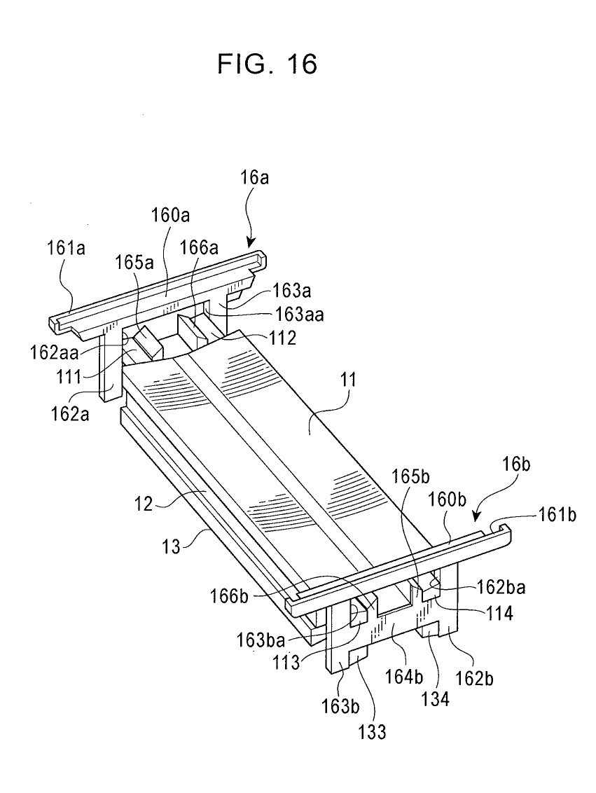

As shown in FIG. 14, a magnetic plate 12 is layered over a second inner yoke 13, and further, as shown in FIG. 15, a first inner yoke 11 is layered over the magnetic plate 12, whereby the magnetic plate 12 is sandwiched between the first inner yoke 11 and the second inner yoke 13. Note that at this time, the magnetic plate 12 is in a demagnetized state. Next, as shown in FIG. 16, the first inner yoke 11 and the second inner yoke 13 which are in the state of sandwiching the magnetic plate 12 are subjected to positioning by the first positioning member 16a and the second positioning member 16b. Specifically, the positioning protrusion 111 of the first inner yoke 11 is subjected to positioning by the inner face 162aa of the first horizontal spacer unit 162a and the first positioning face 164aa of the vertical spacer unit 164a (see FIG. 6A), in the state of being sandwiched between the first horizontal spacer unit 162a and the protruding portion 165a of the vertical spacer unit 164a of the first positioning member 16a, and the positioning protrusion 112 of the first inner yoke 11 is subjected to positioning by the inner face 163aa of the second horizontal spacer unit 163a and the second positioning face 164ab of the vertical spacer unit 164a (see FIG. 6A), in the state of being sandwiched between the second horizontal spacer unit 163a and the protruding portion 166a of the vertical spacer unit 164a of the first positioning member 16a. Also, the positioning protrusion 113 of the first inner yoke 11 is subjected to positioning by the inner face 163ba of the second horizontal spacer unit 163b and the second positioning face 164bb of the vertical spacer unit 164b (see FIG. 6B), in the state of being sandwiched between the second horizontal spacer unit 163b and the protruding portion 166b of the vertical spacer unit 164b of the second positioning member 16b, and the positioning protrusion 114 of the first inner yoke 11 is subjected to positioning by the inner face 162ba of the first horizontal spacer unit 162b and the first positioning face 164ba of the vertical spacer unit 164b (see FIG. 6B), in the state of being sandwiched between the first spacer unit 162b and the protruding portion 165b of the vertical spacer unit 164b of the second positioning member 16b.

Further, although not clearly shown in FIG. 16, the second inner yoke 13 is also subjected to positioning by the first positioning member 16a and the second positioning member 16b, similar to the first inner yoke 11. That is to say, the positioning protrusion 131 of the second inner yoke 13 is subjected to positioning by the inner face 162aa of the first horizontal spacer unit 162a and the lower face of the vertical spacer unit 164a in the first positioning member 16a (see FIG. 6A), and the positioning protrusion 132 of the second inner yoke 13 is subjected to positioning by the inner face 163aa of the second horizontal spacer unit 163a and the lower face of the vertical spacer unit 164b in the first positioning member 16a (see FIG. 6A). Also, the positioning protrusion 133 of the second inner yoke 13 is subjected to positioning by the inner face 163ba of the second horizontal spacer unit 163b and the lower face of the vertical spacer unit 164b in the second positioning member 16b, and the positioning protrusion 134 of the second inner yoke 13 is subjected to positioning by the inner face 162ba of the first horizontal spacer unit 162b and the lower face of the vertical spacer unit 164 in the second positioning member 16b.

Thus, the first inner yoke 11 and the second inner yoke 13 having sandwiched the magnetic plate 12 are subjected to positioning in the horizontal direction by the first positioning member 16a and the second positioning member 16b, and the spacing between the first inner yoke 11 and the second inner yoke 13 is maintained at a thickness of the vertical spacer units 164a and 164b (corresponding to the thickness of the magnetic plate 12).

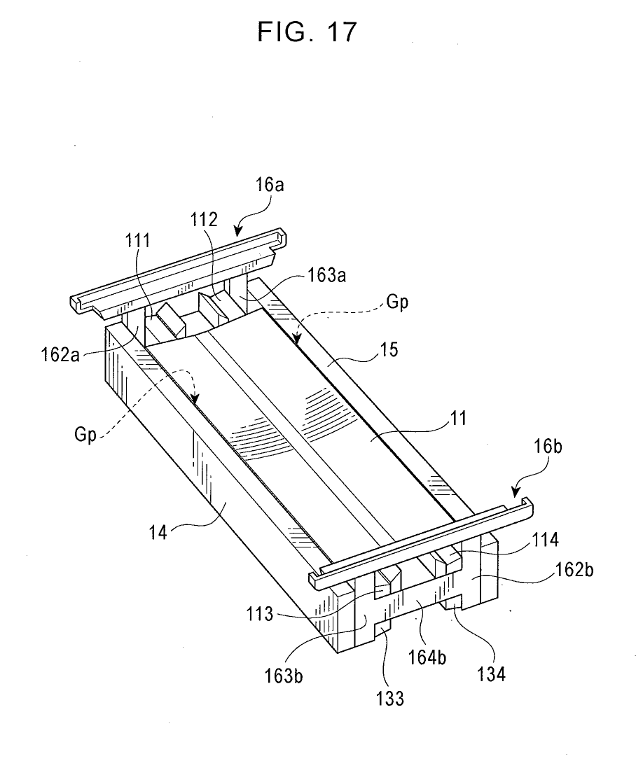

In such a state, as shown in FIG. 17, the first outer yoke 14 is pushed against the first horizontal spacer unit 162a of the first positioning member 16a and the second horizontal spacer unit 163b of the second position determining member 16b, and the second outer yoke 15 is pushed against the second horizontal spacer unit 163a of the first position determining member 16a and the first horizontal spacer unit 162b of the second positioning member 16b. Thus, the space between each of the positioning protrusions 111, 113, 131, and 133 of the first inner yoke 11 and the second inner yoke 13 and the plate face of the first outer yoke 14 is held at a spacing equivalent to the width of the first horizontal spacer unit 162a of the first positioning member 16a and the second horizontal spacer unit 163b of the second positioning member 16b, and the space between each of the positioning protrusions 112, 114, 132, and 134 of the first inner yoke 11 and the second inner yoke 13 and the plate face of the second outer yoke 15 is held at a spacing equivalent to the width of the second horizontal spacer unit 163a of the first positioning member 16a and the first horizontal spacer unit 162b of the second positioning member 16b. Consequently, as shown in the details of FIG. 2 as well as FIG. 17, a magnetic gap Gp is formed between the plate face of the first outer yoke 14 and one of the side end faces of each of the first inner yoke 11 and the second inner yoke 13, and a magnetic gap Gp is formed between the plate face of the second outer yoke 15 and the other side end face of each of the first inner yoke 11 and the second inner yoke 13.

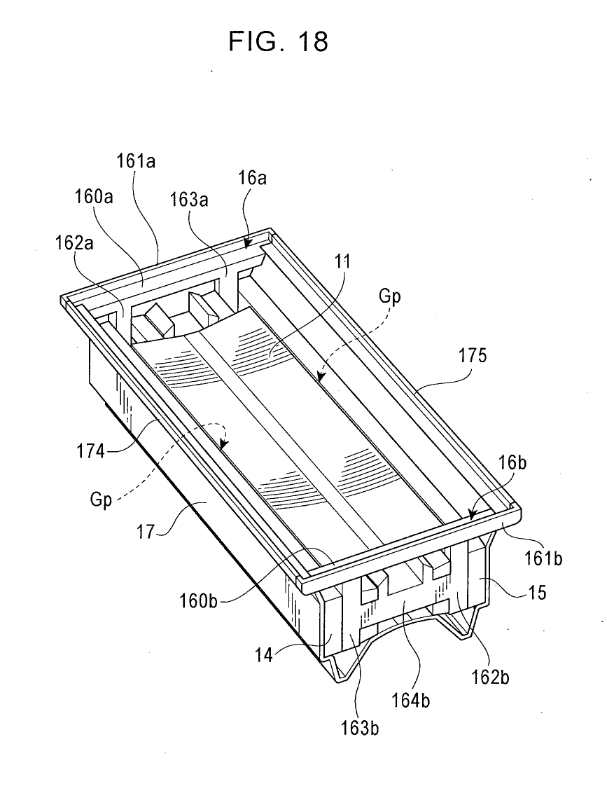

Next, the first inner yoke 11 and the second inner yoke 13 subjected to positioning by the first positioning member 16a and the second positioning member 16b in the state of sandwiching the magnetic plate 12, and the first outer yoke 14 and the second outer yoke 15, are contained within the frame member 17, as shown in detail in FIG. 2 as well as in FIG. 18. The floor portion 171 of the frame member 17 presses the second inner yoke 13 against the vertical spacer units 164a and 164b of the first positioning member 16a and the second positioning member 16b, and the first pressing unit 172 and the second pressing unit 173 of the frame member 17 sandwiches the first outer yoke 14 and the second outer yoke 15, whereby the first outer yoke 14 is pressed by the first horizontal spacer unit 162a of the first positioning member 16a and the second horizontal spacer unit 163b of the second position determining unit 16b, and the second outer yoke 15 is pressed by the second horizontal spacer unit 163a of the first positioning member 16a and the first spacer unit 162b of the second positioning member 16b. Thus, the magnetic plate 12, the first inner yoke 11, the second inner yoke 13, the first outer yoke 14, and the second outer yoke 15 which make up the magnetic circuit are integrated along with the first positioning member 16a and the second positioning member 16b.

The ends of the first outer edge portion 174 of the frame member 17 engage with one end of the outer frame unit 161a of the first positioning member 16a and one end of the outer frame unit 161b of the second positioning member 16b, and the ends of the second outer edge portion 175 of the frame member 17 engage with the other end of the outer frame unit 161a of the first positioning member 16a and the other end of the outer frame unit 161b of the second positioning member 16b. Thus, the magnetic circuit made up of the magnetic plate 12, the first inner yoke 11, the second inner yoke 13, the first outer yoke 14, and the second outer yoke 15 is surrounded by a frame unit that is made up of the first outer edge portion 174 and the second outer edge portion 175 of the frame member 17, the outer frame unit 161a of the first positioning member 16a, and the outer frame unit 161b of the second positioning member 16b.

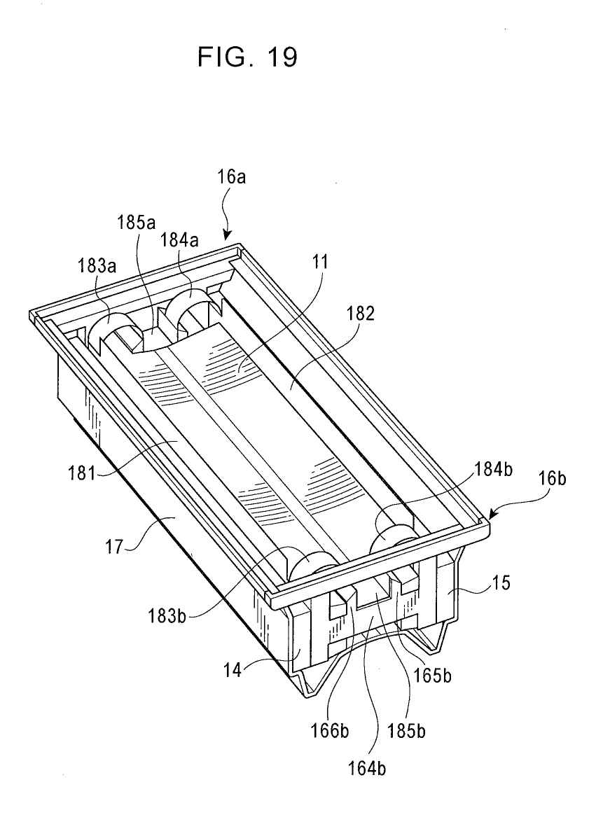

Next, as shown in FIG. 19, the voice coil unit 18 is set in the above-described magnetic circuit (see FIG. 9). Specifically, a first voice coil portion 181 of the voice coil unit 18 is disposed within a magnetic gap Gp which is formed between one of the side end faces of each of the first inner yoke 11 and the second inner yoke 13 and the plate face of the first outer yoke 14, and a second voice coil portion 182 is disposed within a magnetic gap Gp which is formed between the other side end faces of each of the first inner yoke 11 and the second inner yoke 13 and the plate face of the second outer yoke 15 (see FIG. 2). A first terminal unit 185a is fixed to a terminal set face 167a between the two protruding portions 165a and 166a of the vertical spacer unit 164a (see FIG. 6A) in the first positioning member 16a, and a second terminal unit 185b is fixed to a terminal set face 167b between the two protruding portions 165b and 166b of the vertical spacer unit 165b (see FIG. 6B) in the second positioning member 16b. In this state, the first voice coil unit 181 that is disposed within the magnetic gap Gp which is formed between one side end face of each of the first inner yoke 11 and the second inner yoke 13 and the plate face of the first outer yoke 14 has both end portions elastically supported by the first-first supporting unit 183a that is in a shape bent so as to extend up from the first terminal portion 185a and bend down, and a second-first supporting unit 183b that is in a shape bent so as to extend up from the second terminal portion 185b and bend down, and can vibrate within the magnetic gap Gp in the direction of the face thereof (vertical vibration). Also, the second voice coil unit 182 that is disposed within the magnetic gap Gp which is formed between the other side end face of each of the first inner yoke 11 and the second inner yoke 13 and the plate face of the second outer yoke 15 has both end portions elastically supported by the first-second supporting unit 184a that is in a shape bent so as to extend up from the first terminal portion 185a and bend down, and a second-second supporting unit 184b that is in a shape bent so as to extend up from the second terminal portion 185b and bend down, and can vibrate within the magnetic gap Gp in the direction of the face thereof (vertical vibration).

Note that as shown in FIG. 2, the line pattern L11 of a first voice coil line pattern 186 (188) formed in the first voice coil portion 181 is arrayed between one of the side end faces of the first inner yoke 11 and the plate face of the first outer yoke 14, and the line pattern L12 of the first voice coil line pattern 186 (188) is arrayed between one of the side end faces of the second inner yoke 13 and the plate face of the first outer yoke 14. Also, the line pattern L21 of a second voice coil line pattern 187 (189) formed in the second voice coil portion 182 is arrayed between the other side end face of the first inner yoke 11 and the plate face of the second outer yoke 15, and the line pattern L22 of the second voice coil line pattern 187 (189) is arrayed between the other side end face of the second inner yoke 13 and the plate face of the second outer yoke 15.

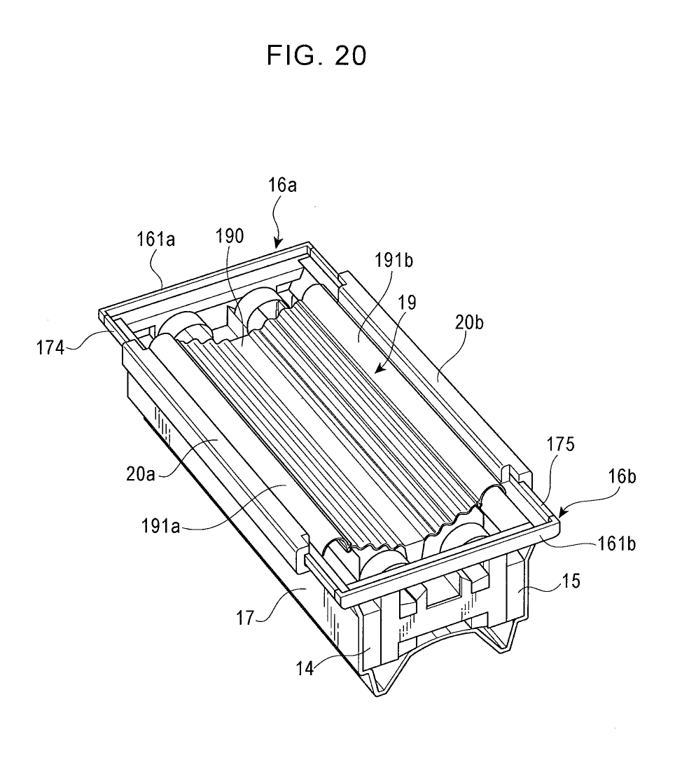

Next, as shown in FIG. 20, a damper member 19 is attached. A first vertical edge portion 20a following a first supporting unit 191a that is formed on one of the outer edge portions of the damper member 19 is fixed to the first outer edge portion 174 of the frame member 17, and a second vertical edge portion 20b following a second supporting unit 191b that is formed on the other outer edge portion of the damper member 19 is fixed to the second outer edge portion 175 of the frame member 17 (see FIG. 2). Thus, the damper member 19 is provided between the first outer edge portion 174 and second outer edge portion 175 of the frame member 17 so as to cover the magnetic circuit and the voice coil unit 18.

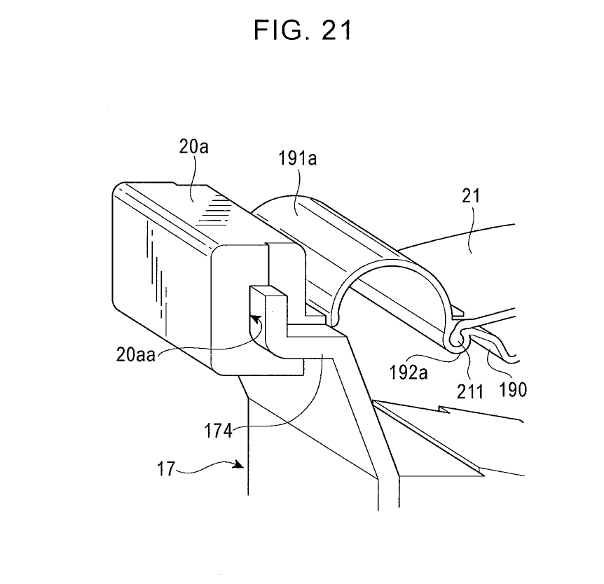

Fixing the damper member 19 to the frame member 17 is performed, specifically, by sliding to fit the first fitting groove 20aa of the first vertical edge unit 20a onto the first outer edge portion 174 of the frame member 17, and similarly sliding to fit the second fitting groove 20ba of the second vertical edge unit 20b onto the second outer edge portion 175 on the opposite side of the frame member 17, as shown expanded in FIG. 21.

When the damper member 19 is attached, the leading edge portion of the first voice coil portion 181 extruding from the magnetic gap Gp is fixed to the border portion between the damper main unit 190 and the first supporting unit 191a (the portion forming the first fitting groove 192a) with an adhesive agent, as shown in FIG. 2. Also, the leading edge portion of the second voice coil portion 182 extruding from the magnetic gap Gp is fixed to the border portion between the damper main unit 190 and the second supporting unit 191b (the portion forming the second fitting groove 192b) with an adhesive agent. Thus, the entire voice coil unit 18 is elastically supported by the damper member 19.

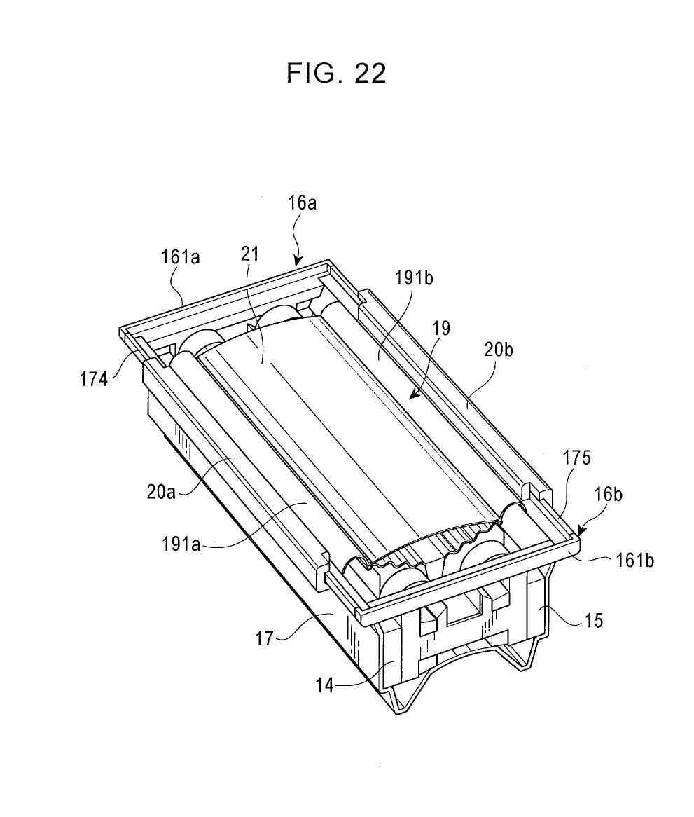

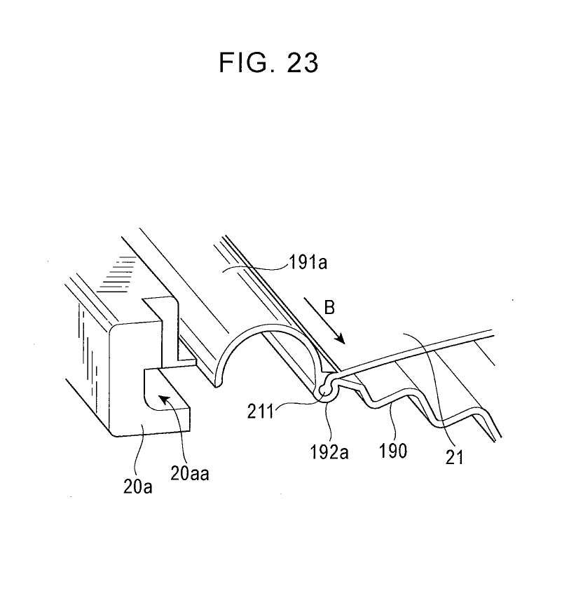

Next, as shown in FIG. 22, the diaphragm 21 is attached to the damper member 19. Specifically, as shown expanded in FIG. 23 as well as FIG. 21, a first sliding unit 211 of the diaphragm 21 is slid to fit into the first fitting groove 192a formed in the border portion between the damper main unit 190 and the first supporting unit 191a. Also, a second sliding unit 212 of the diaphragm 21 is similarly slid to fit into the second fitting groove 192b formed in the border portion between the damper main unit 190 and the second supporting unit 191b. Thus, the diaphragm 21 is fixed to the damper member 19 (damper main unit 190). Also, as described above, the leading end portion of the first voice coil portion 181 of the voice coil unit 18 is adhered to the border portion between the damper main unit 190 and the first supporting unit 191a with an adhesive agent, and also, the leading end portion of the second voice coil portion 182 of the voice coil unit 18 is adhered to the border portion between the damper main unit 190 and the second supporting unit 191b with an adhesive agent (see FIG. 2), whereby the voice coil unit 18 (first voice coil portion 181, second voice coil portion 182) are constructed to link to the diaphragm 21, and the vibrations of the voice coil unit 18 transmit to the diaphragm 21.

Lastly, as shown in FIG. 1, the first horizontal edge portion 22a and the second horizontal edge portion 22b are attached, and the assembly of the various parts is ended. Specifically, the outer frame portions 161a and 161b of the first positioning member 16a and the second positioning member 16b and the first outer edge unit 174 and the second outer edge unit 175 of the frame member 17 are linked to form a rectangular-shaped frame (see FIG. 22). The edge engaging portion 221a of the first horizontal edge unit 22a is fixed to the end portion on the outer frame unit 161a side of the first positioning member 16a of this frame, and the edge engaging portion 221b of the second horizontal edge unit 22b is fixed to the end portion on the outer frame unit 161b side of the second positioning member 16b of the frame. Thus, the edge engaging portions 221a and 222a are linked to the first vertical edge portion 20a and the second vertical edge portion 20b, and the edge cover units 222a and 222b link to the diaphragm 21 and the end edge of the damper member 19 (first supporting unit 191a and second supporting unit 191b).

When the various parts are thus assembled, the magnetic plate is magnetized. When the magnetic plate 12 is magnetized, the first inner yoke 11, the second inner yoke 13, the first outer yoke 14, and the second outer yoke 15 are drawn to the magnetic plate 12, and these are strongly integrated along with the first positioning member 16a and the second positioning member 16b. However, it should be noted that the magnetic gap Gp between one of the side end faces of each of the first inner yoke 11 and the second inner yoke 13 and the plate face of the first outer yoke 14, and the magnetic gap Gp between the other side end faces of each of the first inner yoke 11 and the second inner yoke 13 and the plate face of the second outer yoke 15 are accurately maintained by the first positioning member 16a and the second positioning member 16b.

Note that the parts that are assembled as described above may be adhesively fixed with an adhesive agent as needed before the magnetic plate 12 is magnetized.

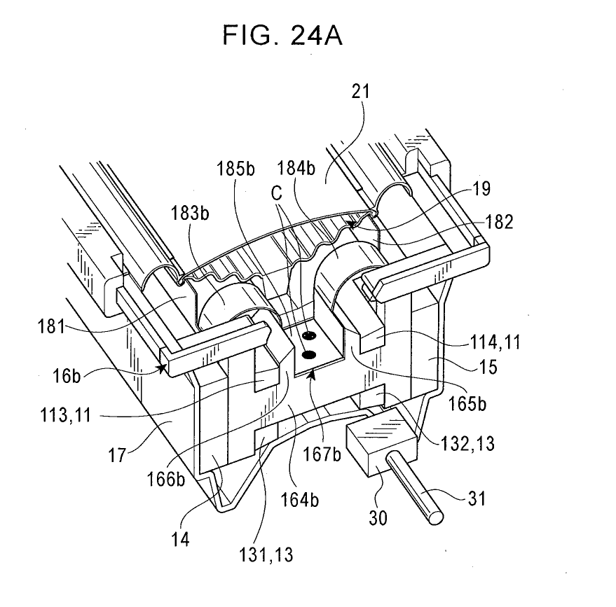

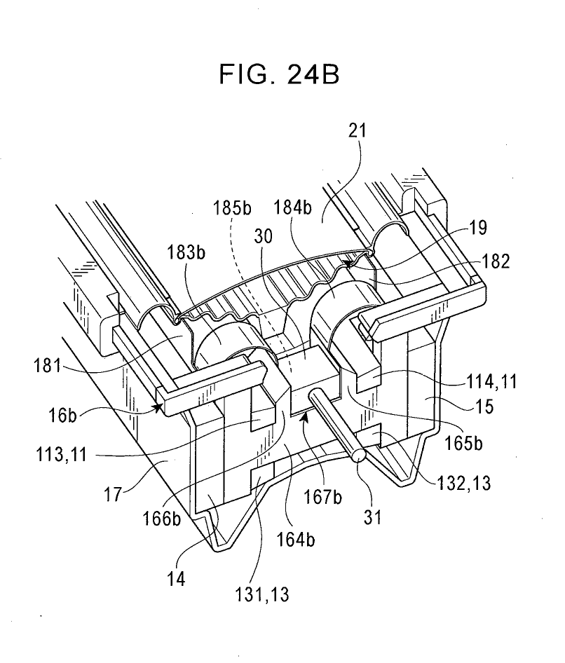

The electrical connection with the audio signal output circuit of the voice coil unit 18 is as shown in FIGS. 24A and 24B. Note that FIGS. 24A and 24B show an expanded view of the configuration of the second terminal unit 185b of the voice coil unit 18, and the first terminal unit 185a of the voice coil unit 18 has the same configuration. Note that in this case, a voice coil line pattern (first voice coil line pattern 188, second voice coil line pattern 189) such as shown in FIG. 13B, for example, is formed in the first voice coil portion 181 and the second voice coil portion 182 of the voice coil unit 18.

In FIG. 24A, in the U-shape formed by the two protruding portions 165b and 166b and the terminal set face 167b of the vertical spacer unit 164b of the second positioning member 16b (fixed position), the second terminal unit 185b is set in the border portion between the second-first supporting unit 183b following the first voice coil portion 181 and the second-second supporting portion 184b following the second voice coil portion 182. A pair of connecting points C of the second voice coil line pattern 189 are formed on the second terminal unit 185b so as to be exposed. A coupler terminal 30 is connected to the leading edge of a lead line 31 extending from the audio signal output circuit. The coupler terminal 30 is made of resin and has an exterior shape that matches the U-shaped second terminal unit 185b of the voice coil unit 18. As shown in FIG. 24B, when the coupler terminal 30 is inserted into the second terminal unit 185b that is set in a U-shape formed with the two protruding portions 165b and 166b and the terminal set face 167b of the vertical spacer unit 164b of the second positioning member 16b, a connecting point (not shown) that becomes a pair following the lead line 31 of the coupler terminal 30 is pressed to make contact with the connecting points C of the second terminal unit 185b. Thus, the lead line 31 and the second voice coil line pattern 189 are electrically connected, and the audio signal supplied from the audio signal output circuit through the lead line 31 is supplied to the second voice coil line pattern 189 via the connecting points C of the second terminal unit 185b.

As described above, although the first terminal unit 185a on the opposite side from the second terminal unit 185b of the voice coil unit 18 is not shown in FIGS. 24A and 24B, similar to the case of the second terminal unit 185b, a coupler terminal connected to the lead line is also inserted into the first terminal unit 185a that is set in a U-shape formed with the two protruding portions 165a and 166a and the terminal set face 167a of the vertical spacer unit 164a of the first positioning member 16a. Thus, the audio signal supplied from the audio signal output circuit through the lead line 31 is supplied to the first voice coil line pattern 188 formed on the first voice coil portion 181 via the connecting points of the first terminal unit 185a.

The same audio signal can be supplied in parallel to the first voice coil line pattern 188 formed in the first voice coil portion 181 and the second voice coil line pattern 189 formed in the second voice coil portion 182. Also, audio signals of frequency features (e.g., for higher sounds and for lower sounds) that differ for the first voice coil line pattern 188 and the second voice coil line pattern 189 can be supplied. Further, audio signals (e.g. vocal audio and instrumental audio) that differ for the first voice coil line pattern 188 and the second voice coil line pattern 189 can be supplied.

Note that even in a case that a voice coil line pattern (first voice coil line pattern 186, second voice coil line pattern 187) such as shown in FIG. 13A, for example, is formed in the first voice coil portion 181 and the second voice coil portion 182 of the voice coil unit 18, by fitting a similar coupler terminal into the first terminal unit 185a or the second terminal unit 185b of the voice coil unit 18, audio signals can be supplied to the first voice coil line pattern 186 and the second voice coil line pattern 187 via the two pairs of connecting points. Note that a dummy coupler terminal can be inserted into a first terminal unit 185a or a second terminal unit 185b to which audio signals are not supplied.

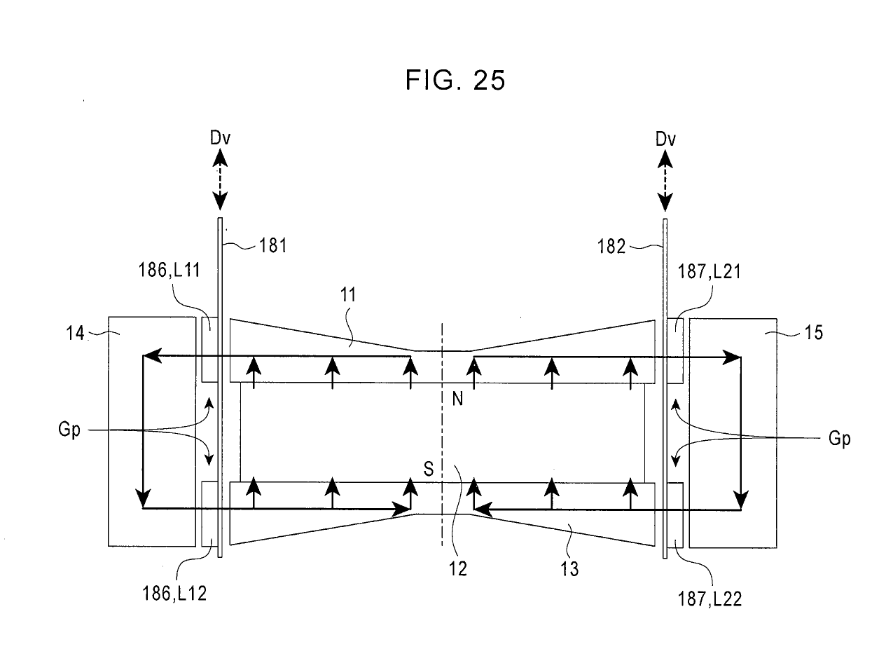

A magnetic flux is generated, as shown in FIG. 25, in the magnetic circuit (magnetic plate 12, first inner yoke 11, second inner yoke 13, first outer yoke 14, and second outer yoke 15). In FIG. 25, the magnetic flux from the North pole side of the magnetic plate 12 travels from one side face of the first inner yoke 11, cuts across the magnetic gap Gp, arrives at the first outer yoke 14, and the magnetic flux having passed through the first outer yoke 14 travels from the first outer yoke 14, cuts across the magnetic gap Gp, arrives at one side end face of the second inner yoke 13, and returns to the South pole side of the magnetic plate 12. Also, the magnetic flux from the North pole side of the magnetic plate 12 travels from the other side end face of the first inner yoke 11, cuts across the magnetic gap Gp, arrives at the second outer yoke 15, and the magnetic flux having passed through the second outer yoke 15 travels from the second outer yoke 15, cuts across the magnetic gap Gp, arrives at the other side end face of the second inner yoke 13, and returns to the South pole side of the magnetic plate 12.

An audio signal is supplied to the first voice coil line pattern 186 (L11, L12) and the second voice coil line pattern 187 (L21, L22) of the voice coil unit 18 via the coupler terminal 30 in the state that the magnetic flux is formed in the magnetic circuit as shown in FIG. 25. In FIG. 25, the magnetic flux that cuts across the magnetic gap Gp formed between one of the side end faces of the first inner yoke 11 and the plate face of the first outer yoke 14, and the magnetic flux that cuts across the magnetic gap Gp formed between one of the side end faces of the second inner yoke 13 and the plate face of the first outer yoke 14, go in opposite directions, but the direction of the audio current flowing between the line pattern L11 and the line pattern L12 of the first voice coil line pattern 186 arrayed within each magnetic gap Gp also goes in opposite directions, whereby within the face of the first voice coil portion 181, force acts in the same direction on the line pattern L11 and line pattern L12 by mutual action of the magnetic flux within the magnetic gap Gp and the audio signal current, and the first voice coil portion 181 vibrates in the direction of the face thereof (vertical direction) Dv according to the audio signal.

Also, in FIG. 25, the magnetic flux that cuts across the magnetic gap Gp formed between the other side end face of the first inner yoke 11 and the plate face of the second outer yoke 15, and the magnetic flux that cuts across the magnetic gap Gp formed between the other side end face of the second inner yoke 13 and the plate face of the second outer yoke 15, similarly go in opposite directions. In this case also, the direction of the audio current flowing between the line pattern L21 and the line pattern L22 of the second voice coil line pattern 187 arrayed within each magnetic gap Gp also goes in opposite directions, whereby force operates in the same direction within the face of the second voice coil unit 182 on the line pattern L21 and line pattern L22 by the mutual action of the magnetic flex within the magnetic gap Gp and the audio signal current, and the second voice coil portion 182 vibrates according to the audio signal, similar to the first voice coil portion 181, in the face direction thereof (vertical direction) Dv.

With the vertical direction Dv vibrations of the first voice coil portion 181 and the second voice coil portion 182 according to the audio signal, the diaphragm 21 which is linked to the voice coil portions 181 and 182 vibrates according to the audio signal. Consequently, sound corresponding to the audio signal is output.

With the speaker device 10 according to the first embodiment as described above, the first-first supporting unit 183a and the second-first supporting unit 183b following the first voice coil portion 181 and the first-second supporting unit 184a and the second-second supporting unit 184b following the second voice coil portion 182 are formed so as to be continuous, whereby the first voice coil portion 181, the second voice coil portion 182, the first-first supporting unit 183a, the second-first supporting unit 183b, the first-second supporting unit 184a, the second-second supporting unit 184b, the first terminal unit 185a, and the second terminal unit 185b can be made of a single flat piece of flexible material, and the configuration of the voice coil unit 18 can become simpler.

Also, the first-first supporting unit 183a and the first-second supporting unit 184a that follow from one end portion of the first voice coil portion 181 and the second voice coil portion 182 elastically support one end portion of the first voice coil portion 181 and the second voice coil portion 182 in a shape bent so as to extend up from the first terminal unit 185a which is fixed to the first positioning member 16a, and to bend down, and the second-first supporting unit 183b and the second-second supporting unit 184b that follow from the other end portion of the first voice coil portion 181 and the second voice coil portion 182 elastically support the other end portion of the first voice coil portion 181 and the second voice coil portion 182 in a shape bent so as to extend up from the second terminal unit 185b which is fixed to the second positioning member 16b, and to bend down, whereby in the event that the first voice coil portion 181 and the second voice coil portion 182 vibrate within the magnetic gap Gp in the direction of the faces thereof, each of the first-first supporting unit 183a and the second-first supporting unit 183b are subject to the bent shape being deformed in accordance with the vibrations of the first voice coil portion 181 while the vibrations of the first voice coil portion 181 are maintained, and also, each of the first-second supporting unit 184a and the second-second supporting unit 184b are subject to the bent shape being deformed in accordance with the vibrations of the second voice coil portion 182 while the vibrations of the second voice coil portion 182 are maintained.

Thus, in the event of the first voice coil portion 181 and the second voice coil portion 182 vibrating within the magnetic gap Gp in the face directions thereof, each of the first-first supporting unit 183a and the second-first supporting unit 183b and the first-second supporting unit 184a and the second-second supporting unit 184b are subject to the bent shape being deformed in accordance with the vibrations of the first and second voice coil portions 181 and 182 while the vibrations of the first voice coil portions 181 and 182 are maintained, whereby in the amount that the bent shape of the various supporting units 183a, 183b, 184a, and 184b are deformed, the amplitude of the vibrations of the first and second voice coil portions 181 and 182 that are elastically supported can be increased. Accordingly, the voice coil unit 18 (first voice coil portion 181, second voice coil portion 182a) can vibrate with a greater amplitude.

Also, in the magnetic circuit, the positioning of the first inner yoke 11, the second inner yoke, the first outer yoke 14, and the second outer yoke 15 are determined by the first positioning member 16a and the second positioning member 16b so that the magnetic gap Gp is formed, and the magnetic plate 12, the first inner yoke 11, the second inner yoke 13, the first outer yoke 14, and the second outer yoke 15 are in an integrated configuration, whereby the magnetic circuit can be assembled with good workability by the first positioning member 16a and the second positioning member 16b. Further, other parts are attached to the first positioning member 16a and the second positioning member 16b, specifically, the frame member 17, the voice coil unit 18, and the first horizontal edge portion 22a and the second horizontal edge portion 22b, whereby assembly workability is further improved.

Also, an electrical connection with the audio signal output circuit of the voice coil unit 18 is made by the coupler terminal 30 that is fit into the first terminal unit 185a and the second terminal unit 185b of the voice coil unit 18 which has been set in the first and second positioning members 16a and 16b (see FIGS. 24A and 24B), whereby electrical connections thereof can be made without soldering. Laying of the lead lines as to the voice coil unit 18 becomes simpler, and assembly is easier. Further, unnecessary load, such as being pulled by the lead line to the voice coil unit 18, can be prevented.

Note that with the speaker device according to the embodiment as described above, the first voice coil portion 181 and the second voice coil portion 182 are disposed in two magnetic gaps Gp (see FIG. 2), but a magnetic circuit can be configured such that the voice coil portions 181 and 182 are disposed in a single magnetic gap Gp. In this case, the voice coil line pattern formed in each voice coil portion 181 and 182 is formed so as to be disposed within a single magnetic gap Gp.

Also, the voice coil unit 18 has the first voice coil portion 181 and the second voice coil portion 182 made of a single flat flexible board (see FIGS. 13A and 13B), but a configuration may be made wherein each are separately elastically supported. In this case, for example, the first-first supporting unit 183a, the second-first supporting unit 183b, the first-second supporting unit 184a, and the second-second supporting unit 184b which elastically support the first voice coil portion 181 and the second voice coil portion 182 each may have the edge portion thereof fixed separately.

As described above, the speaker device according to the present invention is advantageous in that the voice coil unit can vibrate with a greater amplitude, and is useful as a speaker device that outputs sound by causing vibration of a diaphragm which is connected to a voice coil by mutual action between a magnetic field generated in a magnetic circuit and an audio signal current that flows through the voice coil.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A speaker device comprising:
a magnetic circuit forming a magnetic gap;
a voice coil unit disposed in said magnetic gap; and
a diaphragm linked to the voice coil unit;
said voice coil unit further having
a voice coil portion wherein a voice coil line pattern is formed on the surface of a flat material; and
a supporting unit that elastically supports said voice coil portion, which is formed following an end portion of said voice coil portion of said flat material;
wherein an end portion of said supporting unit which is at an opposite side from said voice coil portion is fixed to a fixing position to enable vibration of said voice coil portion within said magnetic gap in the direction of the face thereof;
and wherein the supporting unit elastically supports said voice coil portion in a shape that extends up and bends down from said end portion that is fixed to said fixing position.

2. The speaker device according to claim 1, wherein a connecting point is formed at said end portion fixed to said fixing position of said supporting unit of said voice coil unit, and a line pattern following said connecting point through said voice coil line pattern is formed on said supporting unit.

3. The speaker device according to claim 1, further comprising:
a positioning member that determines the positions of parts making up said magnetic circuit;
wherein said fixing position to which said end portion of said supporting unit of said voice coil unit is fixed is set in said positioning member.

4. The speaker device according to claim 2, wherein said fixing position to which said end portion of said supporting unit of said voice coil unit on which said connecting point is formed is fixed, is set so as to be a concave portion;
and wherein, by fitting a terminal member having a connecting point to make contact with said connecting point in said concave portion, an audio signal is supplied to said voice coil line pattern via the terminal member.

5. A speaker device comprising:
a magnetic circuit forming a magnetic gap;
a voice coil unit disposed in said magnetic gap; and
a diaphragm linked to the voice coil unit;
said magnetic circuit further forming two facing magnetic gaps; and
said voice coil unit further having
a first voice coil portion comprising a first voice coil line pattern on the surface of a flat flexible material;
a second voice coil portion comprising a second voice coil line pattern on the surface of a flat flexible material;
a first-first supporting unit and a second-first supporting unit which is formed following edge portions of said first voice coil portion of said flat flexible material, and which elastically support said first voice coil unit;
a first-second supporting unit and a second-second supporting unit which is formed following edge portions of said second voice coil portion of said flat flexible material, and which elastically support said second voice coil unit;
wherein an edge portion of each of said first-first supporting unit and said second-first supporting unit on a side opposite from said first voice coil portion is fixed to a fixing position so as to enable vibration of said first voice coil portion in one of the magnetic gaps in the direction of the face thereof;
wherein an edge portion of each of said first-second supporting unit and said second-second supporting unit on a side opposite from said second voice coil portion is fixed to a fixing position so as to enable vibration of said second voice coil portion in the other of the magnetic gaps in the direction of the face thereof;
wherein each of said first-first supporting unit and said second-first supporting unit elastically supports said first voice coil unit in a bent shape that extends up from said end portion fixed to said fixing position and bends down;
and wherein each of said first-second supporting unit and said second-second supporting unit elastically supports said second voice coil unit in a bent shape that extends up from said end portion fixed to said fixing position and bends down.

6. The speaker device according to claim 5, wherein a connecting point is formed on said end portion fixed to at least one of said fixing positions of said first-first supporting unit and said second-first supporting unit of said first voice coil portion, and a line pattern following said connecting point through said first voice coil line pattern is formed on at least one of said first-first supporting unit and said second-first supporting unit

7. The speaker device according to claim 5, wherein a connecting point is formed on said end portion fixed to at least one of said fixing positions of said first-second supporting unit and said second-second supporting unit of said second voice coil portion, and a line pattern following said connecting point through said second voice coil line pattern is formed on at least one of said first-second supporting unit and said second-second supporting unit.

8. The speaker device according to claim 5, further comprising:
positioning members that determine the position of the parts making up said magnetic circuit, wherein the fixing positions to which the end portions of each of said first-first supporting unit and said second-first supporting unit of said first voice coil portion are fixed and the fixing positions to which the end portions of each of said first-second supporting unit and said second-second supporting unit of said second voice coil portion are fixed, are set in said positioning members.

9. The speaker device according to claim 6, wherein said fixing positions to which at least one of said end portions of said first-first supporting unit and said second-first supporting unit of said first voice coil portion on which said connecting point is formed is fixed is set into a concave portion, and a terminal member having a connecting point to make contact with said connecting point is fit into said concave portion, whereby audio signals are supplied from the outside via the terminal member to said first voice coil line pattern.

10. The speaker device according to claim 7, wherein said fixing positions to which at least one of said end portions of said first-second supporting unit and said second-second supporting unit of said second voice coil portion on which said connecting point is formed is set into a concave portion, and a terminal member having a connecting point to make contact with said connecting point is fit into said concave portion, whereby audio signals are supplied from the outside via the terminal member to said second voice coil line pattern.

11. The speaker device according to claim 5, wherein the first-first supporting unit that follows from one end portion of said first voice coil portion and the first-second supporting unit that follows from one end portion of said second voice coil portion are formed so as to be continuous, and the border portion between said first-first supporting unit and said first-second supporting unit is fixed to a first fixing position;
and wherein the second-first supporting unit that follows from the other end portion of said first voice coil portion and the second-second supporting unit that follows from the other end portion of said second voice coil portion are formed so as to be continuous, and the border portion between said second-first supporting unit and said second-second supporting unit is fixed to a second fixing position.

12. The speaker device according to claim 11, wherein a connecting point is formed on at least one of said border portions between said first-first supporting unit and said first-second supporting unit of said voice coil unit and said border portion between said second-first supporting unit and said second-second supporting unit of said voice coil unit;
and wherein the line pattern that follows said connecting point from said first voice coil line pattern and said second voice coil line pattern is formed on at least one of said first-first supporting unit and said first-second supporting unit and said second-first supporting unit and said second-second supporting unit.

13. The speaker device according to claim 11, further comprising:
a positioning member that determines the position of the parts making up said magnetic circuit,
wherein the fixing position to which the border portion of said first-first supporting unit and said first-second supporting unit of said voice coil unit are fixed, and wherein the fixing position to which the border portion of said second-first supporting unit and said second-second supporting unit of said voice coil unit are fixed, are set in said positioning member.

14. The speaker device according to claim 12, wherein at least one of said first fixing position and said second fixing position, where said connecting point is formed, is set into a concave portion;
and wherein a terminal member having a connecting point to make contact with said connecting point is fit into said concave portion, whereby audio signals are supplied from the outside via the terminal member to said first voice coil line pattern and said second voice coil line pattern.

15. A speaker device comprising:
a magnetic circuit forming a magnetic gap;
a voice coil unit disposed in said magnetic gap; and
a diaphragm linked to the voice coil unit;
said voice coil unit further having
a voice coil portion wherein a voice coil line pattern is formed on the surface of a flat material; and
a supporting unit that elastically supports said voice coil portion, which is formed following an end portion of said voice coil portion of said flat material;
wherein an end portion of said supporting unit which is at an opposite side from said voice coil portion is fixed to a fixing position to enable vibration of said voice coil portion within said magnetic gap in the direction of the face thereof;
and wherein the supporting unit has a curved shape.

16. The speaker device according to claim 15, wherein a connecting point is formed at said end portion fixed to said fixing position of said supporting unit of said voice coil unit, and a line pattern following said connecting point through said voice coil line pattern is formed on said supporting unit.

17. The speaker device according to claim 15, further comprising:
a positioning member that determines the positions of parts making up said magnetic circuit;
wherein said fixing position to which said end portion of said supporting unit of said voice coil unit is fixed is set in said positioning member.

18. The speaker device according to claim 16, wherein said fixing position to which said end portion of said supporting unit of said voice coil unit on which said connecting point is formed is fixed, is set so as to be a concave portion;
and wherein, by fitting a terminal member having a connecting point to make contact with said connecting point in said concave portion, an audio signal is supplied to said voice coil line pattern via the terminal member.
